(19) United States
(12) Patent Application Publication
(10) Pub. No.: US 2009/0114029 A1
(43) Pub. Date: May 7, 2009

(54) ELECTROSTATIC CAPACITANCE DIAPHRAGM TYPE PRESSURE SENSOR

(75) Inventor: Yosuke Ide, Minamitsura-gun (JP)

Correspondence Address: FITZPATRICK CELLA HARPER & SCINTO, 30 ROCKEFELLER PLAZA, NEW YORK, NY, 10112, US

(73) Assignee: CANON ANELVA TECHNIX CORPORATION, Kawasaki-shi (JP)

(21) Appl. No.: 12/260,055

(22) Filed: Oct. 28, 2008

(30) Foreign Application Priority Data
Nov. 6, 2007 (JP) 2007-288562

(51) Int. Cl. G01L 9/12

(52) U.S. Cl. 73/724

(57) ABSTRACT

An electrostatic capacitance diaphragm type pressure sensor which includes a stationary electrode and a diagraph that are arranged to oppose each other, and in which the diaphragm is deformed by an external force and a pressure is obtained from an electrostatic capacitance between the stationary electrode and diaphragm which changes in accordance with deformation of the diaphragm, includes an outer case which surrounds the main body of the sensor, a heater arranged on the inner surface of the outer case, a temperature sensor to measure the temperature inside the outer case, and a temperature adjustment circuit which compares a temperature signal obtained by the temperature sensor with a predetermined value and outputs a drive signal to drive the heater on the basis of the comparison result.

### BACKGROUND OF THE INVENTION

1. Field of the Invention

The present invention relates to an electrostatic capacitance diaphragm type pressure sensor in which temperature is adjusted at a constant level so that the pressure sensor operates with high accuracy.

2. Description of the Related Art

As an example of a pressure sensor to measure the internal pressure of a vacuum apparatus or the like, an electrostatic capacitance diaphragm type pressure sensor is available.

FIG. 5 is a sectional view of an electrostatic capacitance diaphragm type pressure sensor according to a prior art.

In the electrostatic capacitance diaphragm type pressure sensor (to be merely referred to as a “pressure sensor” as well hereinafter), a diaphragm 1 partitions part of a reference pressure chamber 2 provided in the pressure sensor. When the atmospheric pressure acts on the diaphragm 1 through a through hole 3, the diaphragm 1 is displaced in accordance with the strength of the pressure. If the diaphragm 1 is used as one electrode and a stationary electrode 4 is formed in the reference pressure chamber 2 to oppose the diaphragm 1, the electrostatic capacitance between the diaphragm 1 and stationary electrode 4 changes. An electrical circuit 7 detects the amount of this change through a terminal pin 5 and converts it into an electrical signal, which is then output to the outside through an electrical signal connector 8. A sensor case 6 made of a metal or resin material covers the electrical circuit 7 and a structure to detect the pressure.

When the temperature of the environment where, for example, the pressure sensor is installed changes, the diaphragm 1 and reference pressure chamber 2 thermally expand or contract in accordance with a change in environmental temperature. This generates a stress in the diaphragm 1, which acts to displace it. As a result, even when the pressure that should originally be detected by a pressure gauge is constant, the electrical signal output from the electrical signal connector 8 changes to cause an error in the pressure measurement value. As a result, the pressure sensor cannot operate accurately.

An electrostatic capacitance diaphragm type sensor comprising a temperature sensor to measure the environmental temperature is known (see Japanese Patent Laid-Open No. 2001-13025). This suggests a means that renders the electrostatic capacitance diaphragm type sensor least susceptible to the influence of the environmental temperature. More specifically, a pressure sensor employing a temperature correction scheme is possible. According to this scheme, a temperature sensor to measure the environmental temperature is attached to the electrical circuit 7 shown in FIG. 5. The temperature sensor measures the temperature of the pressure sensor. With reference to the measured temperature, the electrical circuit 7 corrects the amount of displacement of the diaphragm occurring due to a difference in thermal expansion coefficient. With the temperature correction scheme, however, the measured temperature does not always coincide with the diaphragm temperature, and the temperature monitor is not sufficiently accurate. This scheme also requires the operation of measuring correction data (data on a correction coefficient with respect to the temperature) to allow temperature correction in advance and inputting it to a correction circuit. A correction function is created by sampling temperatures at equal intervals in the operable temperature range of the sensor and establishing correspondence between the sampled temperatures and sensor output values. The correction circuit, however, has limitations in use as a high-accuracy pressure measurement device because it generates an error at a temperature that was not sampled.

In order to solve this problem, an electrostatic capacitance diaphragm type pressure sensor employing a temperature adjustment scheme is available, in which the temperature of the pressure sensor is made constant regardless of a change in environmental temperature.

FIG. 6 is a sectional view of an electrostatic capacitance diaphragm type pressure sensor employing the temperature adjustment scheme.

This electrostatic capacitance diaphragm type pressure sensor employing the temperature adjustment scheme incorporates a cover 41 and heater 42 to always set the temperatures of a diaphragm 1 and reference pressure chamber 2 in the pressure sensor at constant values. An electrical circuit 7 heats and adjusts the temperature of the interior of the pressure sensor. According to this temperature adjustment scheme, for example, a heater is set in a reference pressure chamber. Another cover or the like provided with a heater covers the space around the heater. Temperature sensors set near the respective heaters are attached to a temperature adjustment circuit to adjust the temperature. With this temperature adjustment scheme, since the temperature of the entire pressure sensor is almost constant and adjusted, the pressure sensor is not easily influenced by the environmental temperature. As a result, a pressure sensor which is more accurate than that employing the temperature correction scheme can be realized.

According to the conventional temperature adjustment scheme, in order to always maintain the entire pressure sensor at a constant temperature, various types of members around the diaphragm incorporate heaters, and these heaters are temperature-adjusted. To perform temperature adjustment, a temperature sensor is attached to a temperature adjustment circuit. Each of the various types of members incorporates such a temperature sensor, and temperature adjustment is performed to maintain the portions where these members are attached at a constant temperature.

When the environmental temperature changes, the temperature of the pressure sensor changes. Before the temperature of the pressure sensor reaches the constant temperature again by temperature adjustment, the temperatures of the members around the diaphragm tend to be uneven. When the pressure sensor temperatures become uneven, the temperature distribution of the surface of the diaphragm is degraded. Hence, a stress is generated in the diaphragm to displace it. As the main body of the pressure sensor such as one manufactured in recent years by the MEMS (Micro Electro-Mechanical Systems) technique becomes compact, if the pressure sensor adopts the temperature adjustment scheme, the heat capacitance of the pressure sensor main body decreases. Then, as the temperature of the surrounding environment changes, the temperature of the entire pressure sensor tends to fluctuate sharply. During temperature adjustment that lasts until the temperature of the pressure sensor becomes constant, the temperature of the entire pressure sensor tends to cause hunching, leading to problems, for example, making it more difficult to maintain a constant temperature. This problem that the measurement value is influenced by the temperature in this manner applies not only to the pressure sensor but also to sensors in general.

### SUMMARY OF THE INVENTION

It is, therefore, an object of the present invention to provide an electrostatic capacitance diaphragm type pressure sensor which is not easily influenced by the environmental temperature and in which the temperature of the entire sensor can be maintained at an even, constant value easily.

According to one aspect of the present invention, there is provided an electrostatic capacitance diaphragm type pressure sensor which includes a stationary electrode and a diagraph that are arranged to oppose each other, and in which the diaphragm is deformed by an external force and a pressure is obtained from an electrostatic capacitance between the stationary electrode and the diaphragm which changes in accordance with deformation of the diaphragm, the sensor comprising:

an outer case which surrounds a main body of the sensor;

a heater arranged on an inner surface of the outer case;

a temperature sensor to measure a temperature inside the outer case; and

a temperature adjustment circuit which compares a temperature signal obtained by the temperature sensor with a predetermined value and outputs a drive signal to drive the heater on the basis of a comparison result.

According to another aspect of the present invention, there is provided an electrostatic capacitance diaphragm type pressure sensor which includes a stationary electrode and a diagraph that are arranged to oppose each other, and in which the diaphragm is deformed by an external force and a pressure is obtained from an electrostatic capacitance between the stationary electrode and the diaphragm which changes in accordance with deformation of the diaphragm, the sensor comprising:

an outer case which surrounds a main body of the sensor;

a heater arranged on an inner surface of the outer case;

a first temperature sensor to measure a temperature inside the outer case;

a second temperature sensor to measure a temperature outside the outer case; and

a temperature adjustment circuit which compares a temperature signal obtained by the first temperature sensor and indicating the temperature inside the outer case with a predetermined value, outputs a drive signal to drive the heater on the basis of a comparison result, calculates a correction output to correct operation of the heater in accordance with a change in temperature outside the outer case which is obtained by the second temperature sensor, and adds the correction output to the drive signal.

According to an electrostatic capacitance diaphragm type pressure sensor of the present invention, the sensor is less influenced by the environmental temperature than with the conventional temperature correction scheme, and the temperature of the entire sensor can be maintained at an even, constant value more easily than with the conventional temperature adjustment scheme. Therefore, the sensor components are less influenced by the heat stress, and the measurement accuracy improves.

According to another electrostatic capacitance diaphragm type pressure sensor of the present invention, temperature sensors to measure the temperatures of inside and outside the outer case separately are provided. A temperature adjustment circuit performs feedback control and feed-forward control. Hence, in addition to the above effect, even when the environmental temperature changes, it can be canceled evenly. This further enhances the effect of maintaining the temperature of the entire sensor always at a constant value.

Further features of the present invention will become apparent from the following description of exemplary embodiments with reference to the attached drawings.

### BRIEF DESCRIPTION OF THE DRAWINGS

FIG. 1 is a sectional view showing an electrostatic capacitance diaphragm type pressure sensor according to the first embodiment of the present invention;

FIG. 2 is a sectional view showing an electrostatic capacitance diaphragm type pressure sensor according to the second embodiment of the present invention;

FIG. 3 is a sectional view of a case in which a carbon sheet 17 made of a material with high thermal conductivity is sandwiched between an outer case 9 and a heater 10 arranged on the inner surface of the outer case 9;

FIG. 4 is a sectional view of a case in which a carbon sheet 17 made of a material with high thermal conductivity is sandwiched between the outer case 9 and heater 10 arranged on the inner surface of the outer case 9 and an Al plate 18 made of a material with high thermal conductivity is added to the outer surface of the outer case 9;

FIG. 5 is a sectional view showing an electrostatic capacitance diaphragm type pressure sensor according to a prior art; and

FIG. 6 is a sectional view showing an electrostatic capacitance diaphragm type pressure sensor which employs a temperature adjustment scheme according to a prior art.

### DESCRIPTION OF THE EMBODIMENTS

Compact electrostatic capacitance diaphragm type pressure sensors which are manufactured using the MEMS technique will be described hereinafter as the first and second embodiments.

### First Embodiment

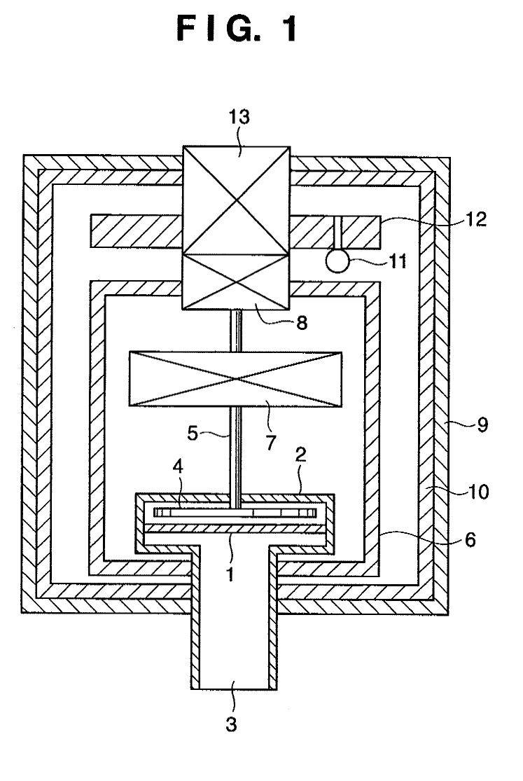

FIG. 1 is a sectional view showing an electrostatic capacitance diaphragm type pressure sensor according to the first embodiment of the present invention.

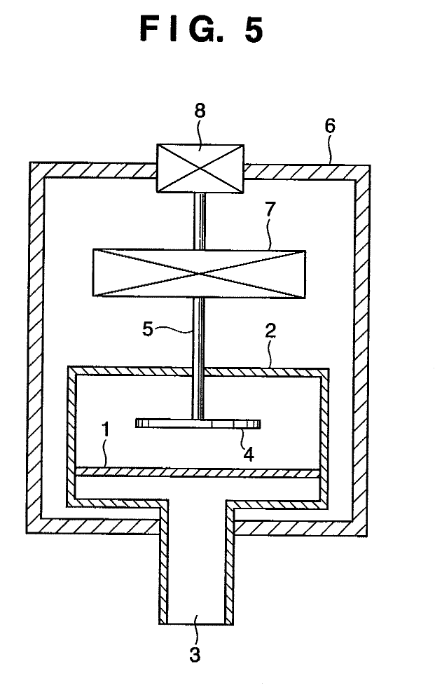

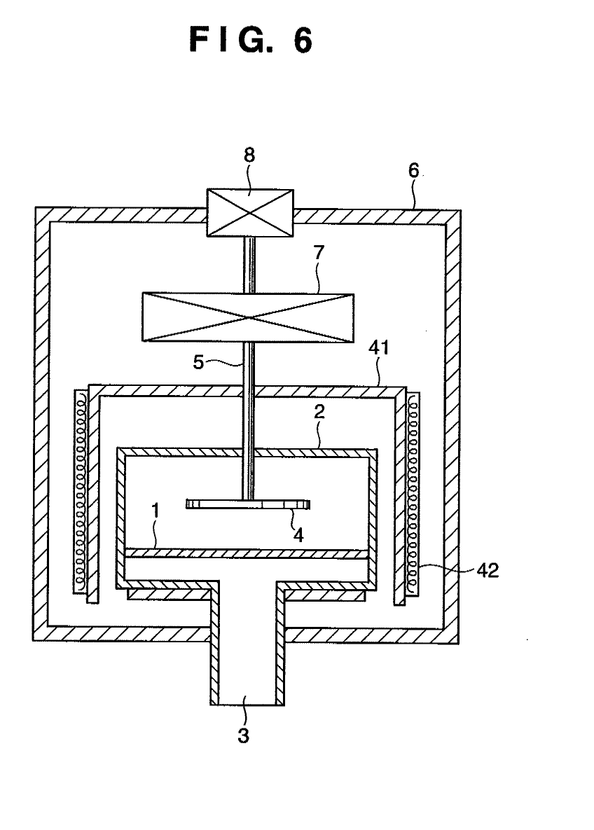

In FIG. 1, portions indicated by reference numerals 1 to 8 are identical to those that constitute the electrostatic capacitance diaphragm type pressure sensor shown in FIG. 5 which employs the MEMS technique. This pressure sensor has a stationary electrode 4 and diaphragm 1 which oppose each other. An external force deforms the diaphragm 1. The pressure is obtained from the electrostatic capacitance between the stationary electrode 4 and diaphragm 1 which changes in accordance with this deformation.

An outer case 9 having an even thickness and made of a resin with low thermal conductivity covers the pressure sensor entirely. A sheet- or film-like heater 10, for example, a rubber heater, which has an equal power per unit area is formed on the inner surface of the outer case 9. In this case, the heater 10 may be adhered to the inner surface of the outer case 9 using a double-sided adhesive tape. A temperature sensor 11 is arranged inside the outer case 9 and measures the temperature inside the outer case 9. A temperature signal sensed by the temperature sensor 11 is input to a temperature adjustment circuit 12. The temperature adjustment circuit 12 compares the input temperature signal with a predetermined value and outputs a drive signal for the heater 10, thus adjusting the temperature inside the outer case 9, that is, the temperature of the pressure sensor. This adjustment is feedback control which is ordinary control.

For example, regarding the heating temperature, the temperature of the internal space of the case is set to 45° C. which is equal to or higher than the environmental temperature (e.g., 15° C. to 35° C.). The temperature adjustment circuit 12 performs PID control of adjusting the temperature inside the outer case 9 which is sensed by the temperature sensor 11 in the outer case 9.

The temperature adjustment circuit 12 is connected to an electrical signal connector 13 provided to the upper portion of the outer case 9 and supplies power to the electrical signal connector 13. The electrical signal connector 13 provided to the upper portion of the outer case 9 is connected to the electrical signal connector 8 of the pressure sensor main body. The through hole 3 extends through the outer case 9 and heater 10 as well.

In this manner, by surrounding the entire pressure sensor with the outer case 9 having a uniform thickness and made of a resin with low thermal conductivity, the thermal insulation properties increase and heat exchange with the environmental atmosphere can be uniformed and reduced. Furthermore, to uniformly heat the temperature of the entire pressure sensor, the heater 10 having an equal power per unit area is arranged on the inner surface of the outer case 9. The temperature inside the outer case 9 is controlled by the temperature sensor 11 and temperature adjustment circuit 12 in the outer case 9, and changes uniformly and moderately when the temperature of the external environment changes. The temperature inside the outer case 9 thus becomes uniform, does not hunch easily, and can be easily maintained at a constant value. As the uniformity of the pressure sensor temperature and that of the temperature around the pressure sensor improve, the heat stress on the diaphragm of the pressure sensor is moderated, so that the pressure measurement value becomes stable.

When this embodiment is employed, the electrostatic capacitance diaphragm type pressure sensor which is made compact using the MEMS technique is less influenced by the environmental temperature than with the conventional temperature correction scheme. The pressure sensor can be made more compact than with the conventional temperature adjustment scheme, and is excellent in reducing the space. The temperature of the entire pressure sensor can be maintained at a uniform, constant value easily, thus improving the pressure measurement accuracy.

Assume that this embodiment is applied to an existing electrostatic capacitance diaphragm type pressure sensor which employs the temperature correction scheme. When the temperature adjustment mechanism of this embodiment is additionally mounted to this existing pressure sensor, the resultant pressure sensor can have an improved function as it has both the temperature correction function and the temperature adjustment function, which is a great advantage.

### Second Embodiment

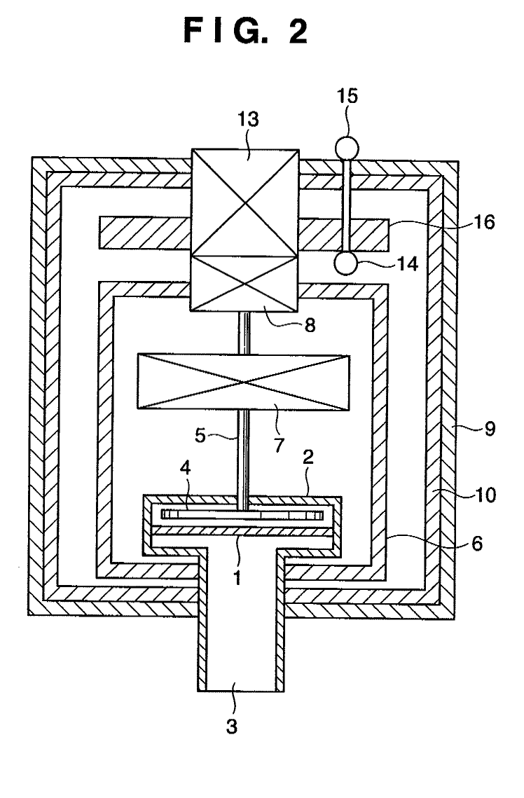

FIG. 2 is a sectional view showing an electrostatic capacitance diaphragm type pressure sensor according to the second embodiment of the present invention.

In FIG. 2, portions indicated by reference numerals 1 to 8 are members that constitute an electrostatic capacitance diaphragm type pressure sensor shown in FIG. 5 which employs the MEMS technique. The difference between the arrangement of the second embodiment and that of the first embodiment will mainly be described hereinafter.

A first temperature sensor 14 is arranged inside an outer case 9 and measures the temperature inside it. A second temperature sensor 15 is arranged outside the outer case 9 and measures the temperature outside it. A temperature adjustment circuit 16 has a circuit portion which receives a temperature signal sensed by the first temperature sensor 14, compares it with a predetermined value, and outputs a drive signal for a heater 10. The temperature inside the outer case 9, that is, the temperature of the pressure sensor, is adjusted in this manner by feedback control as ordinary control. This is the same as in the first embodiment.

The temperature adjustment circuit 16 also has another circuit portion. This circuit portion receives a temperature signal indicating the outside of the outer case 9 which is sensed by the second temperature sensor 15, and calculates an output corresponding to a temperature difference (differential value), that is, a value obtained by multiplying the temperature difference by a coefficient, as a correction output to correct the operation of the heater 10, and adds the correction output to the drive signal for the heater 10. This circuit portion adds the correction output to the drive signal, thus adjusting the correction operation of the heater 10 by feed-forward control to minimize the influence concerning the temperature inside the outer case 9, that is, the temperature of the pressure sensor, as much as possible.

According to this embodiment, temperature sensors to separately measure the temperatures outside and inside the outer case are provided. The temperature adjustment circuit 16 performs feed-forward control in addition to the feedback control of the first embodiment. Hence, in addition to the effect of the first embodiment, even when the temperature of the external environment changes, it can be canceled uniformly. Thus, the temperature of the pressure sensor can always be maintained at a constant value easily. As a result, the pressure measurement accuracy improves and the pressure measurement value stabilizes more quickly.

Examples of an outer case structure that can be additionally applied to the first and second embodiments will be described.

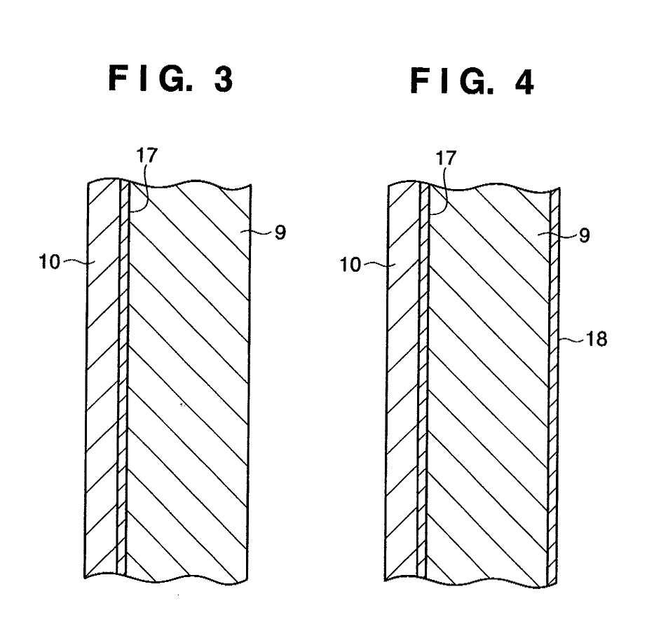

FIG. 3 is a sectional view of a case in which a carbon sheet 17 made of a material with high thermal conductivity is sandwiched between the outer case 9 and the heater 10 arranged on the inner surface of the outer case 9.

A plate or sheet made of a material with high thermal conductivity is sandwiched between the outer case 9 made of a material with low thermal conductivity and the heater 10 arranged on the inner surface of the outer case 9. More specifically, the carbon sheet 17 with high thermal conductivity is set between the outer case 9 having a uniform thickness and made of a resin with low thermal conductivity, and the heater 10, for example, a rubber heat, which is arranged on the inner surface of the outer case 9 and has an equal power per unit area. The carbon sheet 17 serves as a heat equalizing plate, so that the temperature of the inner surface of the outer case 9 becomes more even. As a result, the temperature inside the outer case 9 becomes more even, thus increasing the pressure measurement accuracy. Although a carbon sheet is employed, it can be replaced by another member with high thermal conductivity.

FIG. 4 is a sectional view of a case in which a carbon sheet 17 made of a material with high thermal conductivity is sandwiched between the outer case 9 and the heater 10 arranged on the inner surface of the outer case 9, and an Al plate 18 made of a material with high thermal conductivity is added to the outer surface of the outer case 9.

A plate or sheet made of a material with high thermal conductivity is further added to the outer surface of the outer case 9 shown in FIG. 3. More specifically, in the same manner as the-outer case 9 shown in FIG. 3, the carbon sheet 17 with high thermal conductivity is arranged between the inner surface of the outer case 9 having a uniform thickness and made of a material with low thermal conductivity, and the heater 10, for example, a rubber heat, which has an equal power per unit area. The carbon sheet 17 serves as a heat equalizing plate, so that the temperature of the inner surface of the outer case 9 becomes more even, and the temperature of the interior of the outer case 9 becomes more even. In addition, as the Al plate 18 with high thermal conductivity is added to the outer surface of the outer case 9, it serves as a heat equalizing plate, thus uniforming heat exchange with the environmental temperature outside the outer case 9. As a result, the temperature inside the outer case 9 can become more even, thus further increasing the pressure measurement accuracy.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-288562, filed Nov. 6, 2007, which is hereby incorporated by reference herein in its entirety.

What is claimed is:

1. An electrostatic capacitance diaphragm type pressure sensor which includes a stationary electrode and a diagraph that are arranged to oppose each other, and in which said diaphragm is deformed by an external force and a pressure is obtained from an electrostatic capacitance between said stationary electrode and said diaphragm which changes in accordance with deformation of said diaphragm, said sensor comprising:
an outer case which surrounds a main body of said sensor;
a heater arranged on an inner surface of said outer case;
a temperature sensor to measure a temperature inside said outer case; and
a temperature adjustment circuit which compares a temperature signal obtained by said temperature sensor with a predetermined value and outputs a drive signal to drive said heater on the basis of a comparison result.

2. The sensor according to claim 1, wherein
said outer case is made of a material with low thermal conductivity, and
a member with high thermal conductivity is arranged between said inner surface of said outer case and said heater.

3. The sensor according to claim 1, wherein a member with high thermal conductivity is added to an outer surface of said outer case.

4. An electrostatic capacitance diaphragm type pressure sensor which includes a stationary electrode and a diagraph that are arranged to oppose each other, and in which said diaphragm is deformed by an external force and a pressure is obtained from an electrostatic capacitance between said stationary electrode and said diaphragm which changes in accordance with deformation of said diaphragm, said sensor comprising:
an outer case which surrounds a main body of said sensor;
a heater arranged on an inner surface of said outer case;
a first temperature sensor to measure a temperature inside said outer case;
a second temperature sensor to measure a temperature outside said outer case; and
a temperature adjustment circuit which compares a temperature signal obtained by said first temperature sensor and indicating the temperature inside said outer case with a predetermined value, outputs a drive signal to drive said heater on the basis of a comparison result, calculates a correction output to correct operation of said heater in accordance with a change in temperature outside said outer case which is obtained by said second temperature sensor, and adds the correction output to the drive signal.

5. The sensor according to claim 4, wherein
said outer case is made of a material with low thermal conductivity, and
a member with high thermal conductivity is arranged between said inner surface of said outer case and said heater.

6. The sensor according to claim 4, wherein a member with high thermal conductivity is added to an outer surface of said outer case.

7. The sensor according to claim 1, wherein said heater is adhered to said inner surface of said outer case using a double-sided adhesive tape.

8. The sensor according to claim 4, wherein said heater is adhered to said inner surface of said outer case using a double-sided adhesive tape.
